(19) United States
(12) Patent Application Publication
(10) Pub. No.: US 2020/0167826 A1
(43) Pub. Date: May 28, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Tsugumi OTSUKA, Nagoya-shi (JP); Kazuya NISHIMURA, Okazaki-shi (JP); Yuki ITO, Iwakura-shi (JP); Akio UOTANI, Nagoya-shi (JP); Makoto AKAHANE, Nagoya-shi (JP); Wataru SHIINA, Nagoya-shi (JP)

(73) Assignee: TOYOTA JIDOSHA KABUSHIKI KAISHA, Toyota-shi (JP)

(21) Appl. No.: 16/683,510

(22) Filed: Nov. 14, 2019

(30) Foreign Application Priority Data
Nov. 28, 2018 (JP) 2018-222354

(51) Int. Cl. G06Q 30/02; G05D 1/02; G09F 21/04

(52) U.S. Cl. CPC G06Q 30/0266; G05D 1/0223; G09F 21/048; G05D 1/0291

(57) ABSTRACT

An object is to provide advertisements using a plurality of vehicles with enhanced effectiveness. An information processing apparatus obtains information relating to the speed of a plurality of vehicles passing through a specific area. If a first vehicle leaves the specific area before completing display of an advertisement, the information processing apparatus causes a second vehicle that enters the specific area later than the first vehicle to display the advertisement upon entering the specific area in such a way as to start the display of the advertisement from the point in the advertisement displayed by the display apparatus of the first vehicle at the time of its leaving of the specific area. The aforementioned point in the advertisement is determined based on the speed information.

### CROSS REFERENCE TO RELATED APPLICATION

This application claims the benefit of Japanese Patent Application No. 2018-222354, filed on Nov. 28, 2018, which is hereby incorporated by reference herein in its entirety.

### BACKGROUND

### Technical Field

The present disclosure relates to an information processing apparatus, an information processing method, and a non-transitory storage medium.

### Description of the Related Art

There are known systems configured to cause a plurality of vehicles to display an advertisement in a cooperative manner (see e.g. Patent Literature 1 in the citation list below).

### CITATION LIST

### Patent Literature

Patent Literature 1: Japanese Patent Application Laid-Open No. 2013-089096

### SUMMARY

An object of the present disclosure is to provide an advertisement using a plurality of vehicles with enhanced effectiveness.

According to one aspect of the present disclosure, there is provided an information processing apparatus that causes a plurality of vehicles each provided with a display apparatus capable of displaying an advertisement to the outside to display an advertisement, comprising a controller configured to execute the processing of: obtaining speed information defined as information relating to the speed of the plurality of vehicles passing through a specific area in the specific area, the specific area being such an area that the display apparatuses of the vehicles travelling in this area can be seen from a specific location; and if a first vehicle among the plurality of vehicles that is displaying the advertisement in the specific area leaves the specific area before completing the display of the advertisement, causing a second vehicle among the plurality of vehicles that enters the specific area later than the first vehicle to display the advertisement upon entering the specific area in such a way as to start the display of the advertisement from the point in the advertisement displayed by the display apparatus of the first vehicle at the time of its leaving of the specific area, said point in the advertisement being determined based on the speed information.

According to another aspect of the present disclosure, there is provided an information processing method for causing a plurality of vehicles each provided with a display apparatus capable of displaying an advertisement to the outside to display an advertisement, comprising: obtaining speed information defined as information relating to the speed of the plurality of vehicles passing through a specific area in the specific area, the specific area being such an area that the display apparatuses of the vehicles travelling in this area can be seen from a specific location; and if a first vehicle among the plurality of vehicles that is displaying the advertisement in the specific area leaves the specific area before completing the display of the advertisement, causing a second vehicle among the plurality of vehicles that enters the specific area later than the first vehicle to display the advertisement upon entering the specific area in such a way as to start the display of the advertisement from the point in the advertisement displayed by the display apparatus of the first vehicle at the time of its leaving of the specific area, said point in the advertisement being determined based on the speed information.

According to another aspect of the present disclosure, there is provided a non-transitory storage medium storing a program configured to cause a computer to execute the process of causing a plurality of vehicles each provided with a display apparatus capable of displaying an advertisement to the outside to display an advertisement, the process comprising: obtaining speed information defined as information relating to the speed of the plurality of vehicles passing through a specific area in the specific area, the specific area being such an area that the display apparatuses of the vehicles travelling in this area can be seen from a specific location; and if a first vehicle among the plurality of vehicles that is displaying the advertisement in the specific area leaves the specific area before completing the display of the advertisement, causing a second vehicle among the plurality of vehicles that enters the specific area later than the first vehicle to display the advertisement upon entering the specific area in such a way as to start the display of the advertisement from the point in the advertisement displayed by the display apparatus of the first vehicle at the time of its leaving of the specific area, said point in the advertisement being determined based on the speed information.

According to the present disclosure, it is possible to provide advertisements using a plurality of vehicles with improved effectiveness.

### BRIEF DESCRIPTION OF THE DRAWINGS

FIG. 1 is a diagram illustrating the general configuration of an advertisement display system according to an embodiment.

FIG. 2 illustrates a vehicle.

FIG. 3 illustrates an advertisement to be displayed by display apparatuses of the vehicles.

FIG. 4 is a block diagram illustrating exemplary hardware configurations of a vehicle and a server according to the embodiment.

FIG. 5 is a diagram illustrating an example of the functional configuration of the server.

FIG. 6 illustrates an example of advertisement information stored in an advertisement information database.

FIG. 7 illustrates exemplary records of travel stored in a travel record database.

FIG. 8 illustrates an example of distribution information stored in a distribution information database.

FIG. 9 is a flow chart of an exemplary process of sending information relating to display of an advertisement from a vehicle to a server.

FIG. 10 is a flow chart of an exemplary process of displaying an advertisement on the display apparatus of the vehicle.

FIG. 11 is a flow chart of an exemplary process of managing vehicles.

FIG. 12 is a flow chart of an exemplary process of distributing an advertisement.

FIG. 13 illustrates an example of advertisement information stored in the advertisement information database according to a second embodiment.

FIG. 14 illustrates exemplary distribution information stored in the distribution information database according to the second embodiment.

FIG. 15 is a flow chart of an exemplary process of distributing an advertisement according to the second embodiment.

FIG. 16 illustrates exemplary advertisement information stored in the advertisement information database according to a third embodiment.

FIG. 17 is a flow chart of a process of distributing an advertisement according to the third embodiment.

### DESCRIPTION OF THE EMBODIMENTS

An information processing apparatus according to a mode of the present disclosure is configured to obtain information about the speed of a plurality of vehicles in a specific area. The speed may be obtained by estimation. The aforementioned specific area is an area within which a consumer at a specific location can see display apparatuses of vehicles. In other words, the aforementioned specific area is such an area that the consumer can see the display apparatuses of vehicles that are travelling within this area. The aforementioned specific location may be, for example, a location near an intersection or a crosswalk at which a consumer tends to stop, in other words a location at which a consumer who is not aboard a vehicle is likely to see advertisements displayed by display apparatuses of vehicles. A vehicle travelling in the specific area while displaying an advertisement on its display apparatus allows the consumer at the specific location to see the advertisement. However, in the case where the advertisement is one that changes with time (e.g. a moving image), there may be cases where it is impossible for a vehicle to allow a consumer to see the entirety of the advertisement from the beginning to the end. (In the following, the expression “the entirety of an/the advertisement” will be used in this sense.) Such situations can occur depending on the speed of the vehicle. Specifically, there may be cases where the consumer cannot see the entirety of the advertisement because the vehicle leaves the specific area before completing the display of the advertisement to the end. To avoid such situations from occurring, when a vehicle (first vehicle) goes out from the specific area while displaying an advertisement, the information processing apparatus causes another vehicle (second vehicle) that enters the specific area later to display the continuation of the advertisement to allow the consumer to see it. This process may be performed repetitively to cause vehicles coming one after another to display continuous parts of the advertisement consecutively to allow the consumer to see the entirety of the advertisement. The length of time over which a vehicle can display the advertisement on its display apparatus in the specific area varies depending on the speed of the vehicle. Therefore, the point in the advertisement at which the second vehicle is to start the display of the advertisement is determined on the basis of information about the speed of the first vehicle. As above, the information processing apparatus allows the consumer to see the entirety of the advertisement, thereby enhancing the effectiveness of the advertisement. It is not necessary that the first vehicle and the second vehicle be travelling in the same direction.

The controller may further execute the processing of dividing the advertisement based on the speed information relating to vehicles among the plurality of vehicles that enter the specific area in order and causing the display apparatuses of the vehicles to respectively display the divided portions of the advertisement according to the order of their entrance into the specific area. If the speed of each vehicle can be predicted, the respective lengths of time over which vehicles can display an advertisement in the specific area can also be predicted. The entirety of the advertisement can readily be displayed by dividing the advertisement in advance based on such predicted lengths of time and causing the vehicles to display the divided portions of the advertisement in the order of their entrance into the specific area. The speed of the vehicles can be predicted based on the present speed, the speed limit of roads in the specific area, information about traffic signals, information about traffic jams etc.

The controller may vary the length of the advertisement based on the speed information relating to vehicles among the plurality of vehicles that enter the specific area in a specific period. The specific period is a period over which a consumer stays at a specific location. An example of the specific period is a period through which a pedestrian signal is red. The consumer not aboard a vehicle may leave the specific location after the lapse of some time. For example, if the traffic signal changes, the consumer may move across the road. As the consumer moves away from the specific location, it is probable that the consumer cannot see the entirety of the advertisement, leading to a deterioration in the effectiveness of the advertisement. Hence, it is possible to enhance the effectiveness of advertisement by adjusting the length (or duration) of the advertisement to allow the consumer to see the entirety of the advertisement. For example, a plurality of advertisements having different durations may be prepared in advance, and the advertisement to be displayed is switched according to the speed information.

The controller may be configured to further execute the processing of obtaining traffic information defined as information relating to traffic in the specific area and obtaining the speed information based on the traffic information. Examples of the traffic information includes information about traffic signals and information about traffic jams. Such information relate to the speed of vehicles located in the specific area and therefore to the length of time over which the advertisement displayed by the display apparatuses of the vehicles can be seen from the specific location. For example, when the length of time over which the consumer can see the advertisement is long, the duration of the advertisement may be made long accordingly. This allows a larger amount of information to be displayed by the vehicles, leading to enhanced advertising effectiveness. On the other hand, when the length of time over which the consumer can see the advertisement is short, the duration of the advertisement may be made short accordingly. This allows the entirety of the advertisement to be displayed by the vehicles, leading to enhanced advertising effectiveness.

The higher the speed of the plurality of vehicles in the specific area is, the more the controller decreases the amount of information contained in the advertisement. If, for example, vehicles travel in the specific area at high speed while displaying an advertisement containing a large amount of information, there is a possibility that the consumer cannot grasp the advertisement displayed by the display apparatuses. Such difficulties in consumer's grasping the advertisement can be controlled by decreasing the amount of information contained in the advertisement (e.g. increasing the size of letters or characters or simplifying figures) with increasing speed of the vehicles. On the other hand, when the speed of the vehicles is low, the consumer can readily grasp the advertisement even if the amount of information contained in the advertisement is large. Therefore, a larger amount of information can be provided to the consumer.

In the following, embodiments of the present disclosure will be described. The configurations of the embodiments described in the following are illustrative examples, and the present disclosure are not limited by the configurations of the embodiments. Features of the embodiments may be adopted in any feasible combinations.

### First Embodiment

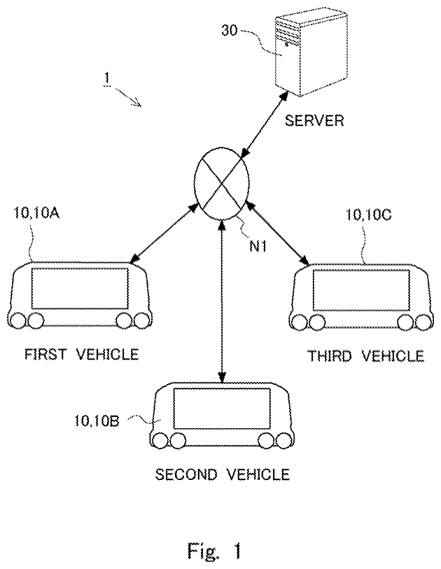

FIG. 1 is a diagram illustrating the general configuration of an advertisement display system 1 according to a first embodiment. The advertisement display system 1 illustrated in FIG. 1 includes a plurality of vehicles 10 each having a display apparatus provided on its outside and causes the vehicles 10 to display an advertisement on the display apparatuses. Examples of the advertisement to be displayed include still images, moving images (videos), slides, and message information. The content of advertisements may include augmented reality (AR) containing visual information produced by computer graphics (CG) or the like and/or projection mapping. In the following, an exemplary case where the advertisement is a moving image will be described. The advertisement display system 1 illustrated in FIG. 1 includes a plurality of vehicles 10 (10A, 10B, 10C) and a server 30. The number of vehicles 10 included in the advertisement display system 1 is not limited to three, but the advertisement display system 1 may include any number of vehicles 10. No limitation is placed on the type of each vehicle 10. The vehicle 10 may be either an autonomous vehicle that can travel autonomously without a driver or a vehicle driven by a driver. The vehicle 10 may be a vehicle intended solely for displaying advertisements.

The vehicles included in the system illustrated in FIG. 1 will be referred to as the first vehicle 10A, the second vehicle 10B, and the third vehicles 10C, where identification of individual vehicles is necessary. The vehicles will also be simply referred to as vehicles 10, where identification of individual vehicles is not necessary. The vehicles 10 and the server 30 are interconnected by a network N1. Examples of the network include a global public network, such as the Internet, and a wide area network (WAN) and other communication networks may be employed. Examples of the network also include a telephone communication network, such as a cellular phone network, and other wireless communication networks, such as Wi-Fi (registered trademark).

The vehicle 10 has a display apparatus provided on its outside. The vehicle 10 receives data of an advertisement (also referred to as advertisement data) from, for example, the server 30. The vehicle 10 can display the advertisement based on the advertisement data on its display apparatus to the outside.

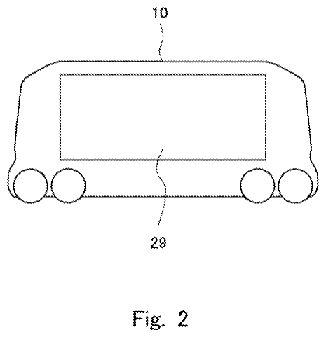

FIG. 2 illustrates the vehicle 10. As illustrated in FIG. 2, a display apparatus 29 is provided on the outside of the body of the vehicle 10. The display apparatus 29 may be provided at any position on the vehicle, such as the left side, right side, front, rear, or top of the vehicle. The vehicle 10 may have a plurality of display apparatuses provided at different positions. A display apparatus may be provided at a position other than those described above. For example, if the vehicle 10 is equipped with a projector, a window pane (e.g. a side window and/or a rear window) on which images can be projected can constitute a display apparatus.

Each of the vehicles 10 sends status information that indicates its own status to the server 30 periodically or in response to a request from the server 30. Examples of the status information include location information (e.g. latitude and longitude) of the vehicle 10, information about its travelling speed (speed information), and information about its travelling direction. The vehicle 10 sends such information to the server 30 with identification data (vehicle ID) that uniquely identifies the vehicle 10. The vehicle ID that identifies each vehicle 10 is assigned to it beforehand.

The server 30 according to the first embodiment manages advertisements to be displayed by the vehicles 10. The server 30 has information relating to advertisements to be displayed by the vehicles 10 and information relating to the vehicles 10 having display apparatuses 29 in its databases. The server 30 receives status information periodically sent from the vehicles 10 connected to the network N1. The server 30 causes the vehicles 10 to display advertisements on the basis of the information received from the vehicles 10.

In an illustrative case, the server 30 divides a video into parts and sends them to a plurality of vehicles that pass through a specific area. In doing so, the server 30 uses location information and speed information received from each of the vehicles 10. The aforementioned parts or partial videos jointly form a single complete video. Specifically, the server 30 calculates lengths of time over which videos (moving images) displayed by the display apparatuses 29 of the respective vehicles 10 can be seen from a specific location. Then, the server 30 divides an advertisement video into partial videos that respectively have the lengths over which they can be seen from the specific location as calculated, according to the order of passing of the vehicles 10 through the specific area and sends the partial videos to the vehicles 10 so as to cause the vehicles 10 to display the respective partial videos while passing through the specific area. Consequently, the first vehicle 10A displays a first partial video, the second vehicle 10B displays a partial video subsequent to the partial video displayed by the first vehicle 10A, and the third vehicle 10C displays a partial video subsequent to the partial video displayed by the second vehicle 10B in the specific area. Thus, the second vehicle 10B allows a consumer located at the specific location to see the continuation of the video displayed by the first vehicle 10A, and the third vehicle 10C allows the consumer to see the continuation of the video displayed by the second vehicle 10B. Therefore, the consumer can see a relatively long video to the end. This can enhance the effectiveness of the advertisement.

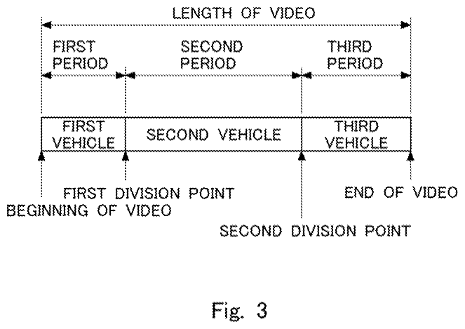

FIG. 3 illustrates an advertisement to be displayed by the display apparatuses 29 of the vehicles 10. FIG. 3 illustrates a case where a video is divided into three parts. In FIG. 3, the time from the beginning to the end of the video is represented by the length in the horizontal direction. In FIG. 3, the first period represents the duration of the partial video to be displayed by the first vehicle 10A, the second period represents the duration of the partial video to be displayed by the second vehicle 10B, and the third period represents the duration of the partial video to be displayed by the third vehicle 10C. In FIG. 3, the first division point is the time point at the boundary of the first period and the second period, and the second division point is the time point at the boundary of the second period and the third period. FIG. 3 illustrates divisions of a video in a case where the first vehicle 10A, the second vehicle 10B, and the third vehicle 10C pass through the specific period in order. The first period is the period over which the display apparatus 29 of the first vehicle 10A can be seen from the specific location, the second period is the period over which the display apparatus 29 of the second vehicle 10B can be seen from the specific location, and the third period is the period over which the display apparatus 29 of the third vehicle 10C can be seen from the specific location. FIG. 3 illustrates divisions of a video in a case where the second vehicle 10B enters the specific area after the first vehicle 10A has left the specific area and the third vehicle 10C enters the specific area after the second vehicle 10B has left the specific area

The server 30 determines the order of vehicles 10 that pass by the specific location and calculates the length of time over which the display apparatus 29 of each vehicle 10 can be seen from the specific location when it passes by the specific location. For example, the server 30 calculates the time taken for each vehicle 10 to pass through the specific area as the length of time over which the display apparatus 29 can be seen from the specific location on the assumption that the vehicle 10 continues to travel at the current speed. The specific area is such an area that the display apparatus 29 can be seen from the specific location if the vehicle is travelling in this area. This specific area may be an area that is set according to the size of the display apparatus 29 or an area that is set in advance without regard to the size of the display apparatus 29. The respective durations of the first, second, and third periods are determined in this way.

Then, the server 30 determines the first division point in accordance with the length of the first period and the second division point in accordance with the length of the first and second periods. Then, the server 30 sends a partial video corresponding to the first period to the first vehicle 10A so that the partial video corresponding to the first period will be displayed by the display apparatus 29 of the first vehicle 10A when the first vehicle 10A enters the specific area. Furthermore, the server 30 sends a partial video corresponding to the second period to the second vehicle 10B so that the partial video corresponding to the second period will be displayed by the display apparatus 29 of the second vehicle 10B when the second vehicle 10B enters the specific area. Moreover, the server 30 sends a partial video corresponding to the third period to the third vehicle 10C so that the partial video corresponding to the third period will be displayed by the display apparatus 29 of the third vehicle 10C when the third vehicle 10C enters the specific area. While the server 30 sends divided videos to the respective vehicles 10 in the above-described case, the server 30 may send the undivided video and information about the division points of the video set for the respective vehicles 10 to the vehicles 10 instead.

There may be a time-lag between leaving of the first vehicle 10A from the specific area and entering of the second vehicle 10B into the specific area in some cases. Even in such cases, the consumer at the specific location can see the entirety of the advertisement video, though there is a certain interval. There may be cases where the second vehicle 10B enters the specific area before the first vehicle 10A leaves the specific area. Then, the consumer can see the display apparatus 29 of the first vehicle 10A and the display apparatus 29 of the second vehicle 10B concurrently. In such cases, the videos may be distributed in such a way that the first vehicle 10A and the second vehicle 10B displays the same point of the video.

The advertisement display system 1 according to the first embodiment can employ a plurality of vehicles to cause them to display a relatively long advertisement that is too long for one vehicle 10 to display in the entirety while passing through the specific area. Therefore, the advertisement display system 1 according to the first embodiment can improve the effectiveness of advertising.

### Hardware Configuration

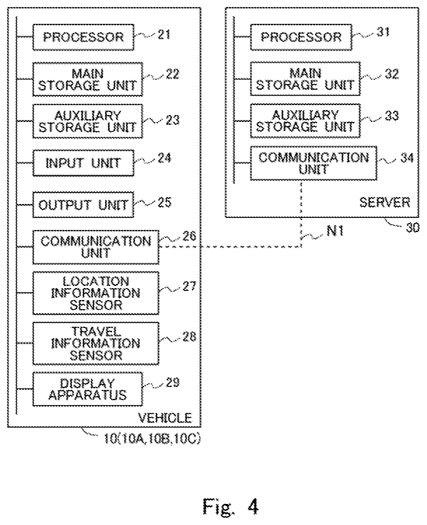

The hardware configurations of the vehicle 10 and the server 30 will be described with reference to FIG. 4. Fig. is a block diagram illustrating exemplary hardware configurations of the vehicle 10 and the server 30 included in the advertisement display system 1 according to the embodiment.

The server 30 has a configuration as an ordinary computer. The server 30 includes a processor 31, a main storage unit 32, an auxiliary storage unit 33, and a communication unit 34. These units are interconnected by busses.

The processor 31 may include a CPU (Central Processing Unit), a DSP (Digital Signal Processor) or the like. The processor 31 controls the server 30 and executes computation of various information processing. The processor 31 constitutes an example of the controller according to the present disclosure. The main storage unit 32 may include a RAM (Random Access Memory), a ROM (Read Only Memory) or the like. The auxiliary storage unit 33 may include an EPROM (Erasable Programmable ROM), a hard disk drive (HDD), a removable medium or the like. The auxiliary storage unit 33 stores an operating system (OS), various programs, and various tables. The processor 31 loads the programs stored in the auxiliary storage unit 33 and executes the programs to control various components. Thus, the server 30 implements functions that serve desired purposes. The main storage unit 32 and the auxiliary storage unit 33 are computer-readable recording media. The server 30 may be either a single computer or a plurality of computers that work cooperatively. Information or data stored in the auxiliary storage unit 33 may be stored in the main storage unit 32 instead. Information or data stored in the main storage unit 32 may be stored in the auxiliary storage unit 33 instead.

The communication unit 34 is means for communicating with the vehicles 10 via the network N1. The communication unit 34 may include a LAN (Local Area Network) interface board or a wireless communication circuit for wireless communication. The LAN interface board or the wireless communication circuit is connected to the network N1.

The processing executed in the server 30 may be executed by either hardware or software. The hardware configuration of the server 30 is not limited to that illustrated in FIG. 4.

Next, the vehicle 10 will be described. The vehicle includes a processor 21, a main storage unit 22, an auxiliary storage unit 23, an input unit 24, an output unit 25, a communication unit 26, a location information sensor 27, a travel information sensor 28, and the display apparatus 29. These units are interconnected by busses. The processor 21, the main storage unit 22, and the auxiliary storage unit 23 are similar to the processor 31, the main storage unit 32, and the auxiliary storage unit 33 of the server 30 and will not be described further.

The input unit 24 is means for receiving input operations made a user. Examples of the input unit 24 include a touch panel and a push button. The output unit 25 is means for presenting information to the user who is aboard the vehicle 10. Examples of the output unit 25 include a liquid crystal display (LCD), an electroluminescence panel (EL panel), a speaker, and a lamp. The input unit 24 and the output unit 25 may be constituted by a touch panel display. The communication unit 26 is communication means for connecting the vehicle 10 to the network N1. An example of the communication unit 26 includes a circuit that performs communication with another apparatus (e.g. the server 30) via the network N1 using a mobile communication service, such as telephone communication network based on 3G (3rd Generation) or LTE (Long Term Evolution) and wireless communication, such as WiFi. The communication unit 26 may enable inter-vehicle communication.

The location information sensor 27 acquires location information of the vehicle 10 at predetermined intervals. Examples of the location information sensor 27 include a GPS (Global Positioning System) receiver and a WiFi communication unit. The travel information sensor 28 is a group of sensors that sense the travelling state of the vehicle 10 and the environment around the vehicle 10. The travel information sensor 28 includes one or more sensors that acquire information about the travelling state of the vehicle and the environment around the vehicle, such as a vehicle speed sensor, an acceleration sensor, a radar, and an azimuth sensor. This information will also be referred to as “travel information” hereinafter. The information acquired by the travel information sensor 28 may include data relating to the degree of traffic congestion in the vicinity of the vehicle 10, data relating to the speed of other vehicles around the vehicle 10, and data relating to control of traffic signals that are obtained by road-to-vehicle communication and inter-vehicle communication. The information acquired by the travel information sensor 28 is recorded in, for example, the auxiliary storage unit 23 with time information and sent to the server 30 with the location information.

Examples of the display apparatus 29 include a liquid crystal display (LCD), an organic electro-luminescence (EL) display, an LED (Light Emitting Diode) matrix, and a projector. The display apparatus 29 is provided on the outside of the vehicle body and faces outward. A plurality of display apparatuses 29 may be provided on each vehicle 10. The vehicle 10 holds information relating to display of an advertisement on the display apparatus 29 in the auxiliary storage unit 23 or other storage units. Examples of the information relating to display of an advertisement include information sent to the vehicle 10 from the server 30. This information may include a group ID, an advertisement ID, advertisement data, and an area ID. The group ID, the advertisement ID, and the area ID will be described later. The information relating to display of an advertisement includes information indicating a portion of the advertisement to be displayed sent to the vehicle 10. This information indicates the start and end points of the portion to be displayed in the advertisement. This information will also be referred to as “display information” hereinafter. The hardware configuration of the vehicle 10 is not limited to that illustrated in FIG. 4. The vehicle 10 according to the first embodiment sends the above-described location information and travel information to the server 30 with identification data (such as vehicle ID or IP address) that uniquely identifies the vehicle.

### Functional Configuration

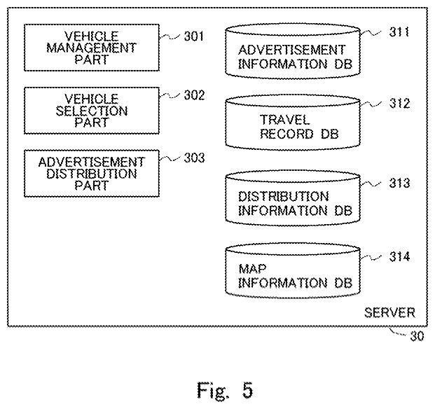

FIG. 5 illustrates an example of the functional configuration of the server 30. The server 30 includes, as functional components, a vehicle management part 301, a vehicle selection part 302, an advertisement distribution part 303, an advertisement information database 311, a travel record database 312, a distribution information database 313, and a map information database 314. The vehicle management part 301, the vehicle selection part 302, and the advertisement distribution part 303 are functional components that are implemented by, for example, executing programs stored in the auxiliary storage unit 33 by the processor 31 of the server 30.

The advertisement information database 311, the travel record database 312, the distribution information database 313, and the map information database 314 are created by managing data stored in the auxiliary storage unit 33 by a database management system program (DBMS program) executed by the processor 31. The advertisement information database 311, the travel record database 312, the distribution information database 313, and the map information database 314 are, for example, relational databases. One or some of the functional components of the server 30 or a part of their processing may be provided by another computer connected to the network N1.

The vehicle management part 301 receives status information sent from the vehicles 10. The status information includes location information acquired by the location information sensor 27 and travel information acquired by the travel information sensor 28. If a vehicle 10 has already been grouped, the vehicle management part 301 receives information relating to display of an advertisement (including group ID, advertisement ID, advertisement data, area ID, and display information) sent from the vehicle 10. The vehicle management part 301 creates a record identified by time information indicating the time at which the status information and the information relating to display of an advertisement are received and stores the record in the travel record database 312. The above described information is managed as a table created for each of the vehicles 10.

The vehicle selection part 302 selects vehicles 10 to be employed to display an advertisement by their display apparatuses based on a specific condition. The specific condition is a condition set for grouping of a plurality of vehicles 10. The specific condition includes status information collected from the vehicles 10. The vehicle selection part 302 passes information about the group of vehicles thus selected to the advertisement distribution part 303.

The advertisement distribution part 303 distributes an advertisement to the selected group of vehicles. The advertisement distribution part 303 stores information about the group of vehicles and the advertisement distributed to the group of vehicles in the distribution information database 313.

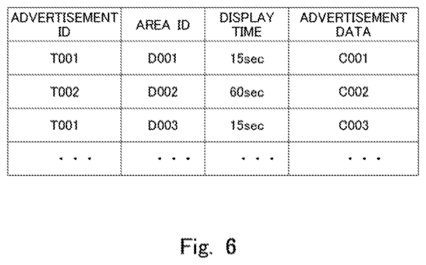

The advertisement information database 311 stores data relating to advertisements to be distributed to grouped vehicles. The server 30 receives data created by advertisers that provide advertisements and stores them in the advertisement information database 311. FIG. 6 illustrates an example of advertisement information stored in the advertisement information database 311. The advertisement information is managed as the advertisement information table as illustrated in FIG. 6. The fields of information stored in the advertisement information table may be added, changed, and deleted fitly.

The exemplary advertisement information table in FIG. 6 includes the fields of advertisement ID, area ID, display time, and advertisement data. What is stored in the advertisement ID field is identification data (i.e. advertisement ID) that identifies an advertisement received from an advertiser. The advertisement ID is assigned to an advertisement when it is entered. What is stored in the area ID field is information (area ID) designating an area in which vehicles 10 are caused to display the advertisement while travelling. The advertisement ID is information identifying the aforementioned specific area. What is stored in the display time field is information indicating the time required to display the entirety of the advertisement, namely the duration of the advertisement. What is stored in the advertisement data field is information relating to the data of the advertisement, such as video data. The information stored in the advertisement data field may be an identification number that designates advertisement data stored in another table or the like.

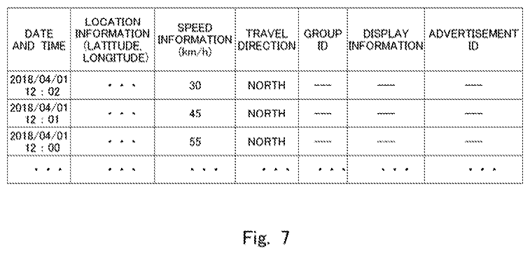

The travel record database 312 stores records of status information received and collected from the vehicles 10. The travel record database 312 stores records of status information for each of the vehicles 10 registered in the advertisement display system 1. FIG. 7 illustrates exemplary records of travel stored in the travel record database 312. The records of travel are managed as a record table for each vehicle 10. The fields of information stored in the record table may be added, changed, and deleted fitly.

The exemplary record table in FIG. 7 includes the fields of date and time, location information, speed information, travel direction, group ID, display information, and advertisement ID. What is stored in the date and time field is information indicating the date and time at which the status information is received. What is stored in the location information field is location information indicating the location (e.g. latitude and longitude) of the vehicle 10 at the present time. What is stored in the speed information field is speed information indicating the speed (in km/h) of the vehicle 10 at the present time. What is stored in the travel direction field is information indicating the direction of travel (e.g. azimuth angle) of the vehicle 10. What is stored in the group ID field is identification data (e.g. group ID) assigned by the server 30 that identifies the vehicle group to which the vehicle 10 belongs. When a group ID is not assigned to the vehicle 10, information indicating that no group ID is assigned (e.g. the sign “---”) is stored in this field or alternatively, this field is left blank.

What is stored in the display information table is information indicating a portion of the advertisement to be displayed. An example of the information stored in this field is information indicating the point in the advertisement from which display of the advertisement is to be started and the point in the advertisement at which display of the advertisement is to be stopped when a vehicle 10 displays a portion of the advertisement. Another example of the information stored in this field is information indicating the point in the advertisement at which display of the advertisement is to be started and information indicating the length of time over which the portion of the advertisement is to be displayed. Specifically, information indicating the first division point and/or the second division point shown in FIG. 3 is stored in this field. Alternatively, information indicating the first, second or third period is stored in this field. If not advertisement is allotted, information indicating the absence of display information (e.g. the sign “---”) is stored in this field or alternatively, this field is left blank.

What is stored in the advertisement ID field is the advertisement ID. When the advertisement ID is absent, in other words, a group ID is not assigned to the vehicle 10, information indicating the absence of the advertisement ID (e.g. the sign “---”) is stored in this field or alternatively, this field is left blank.

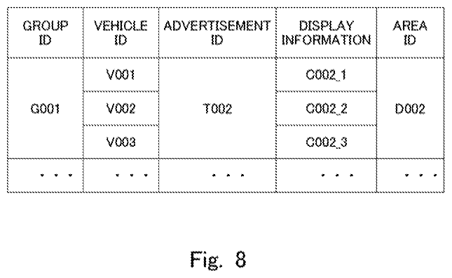

The distribution information database 313 stores information about selected groups of vehicles and information about an advertisement distributed to each of the groups of vehicles. FIG. 8 illustrates an example of distribution information stored in the distribution information database 313. The distribution information is managed as a distribution information table as illustrated in FIG. 8. The fields of information stored in the distribution information table may be added, changed, and deleted fitly.

The exemplary distribution information table in FIG. 8 includes the fields of group ID, vehicle ID, advertisement ID, display information, and area ID. The advertisement ID and the area ID are the same as those in FIG. 6 and will not be described further. The group ID and the display information are the same as those in FIG. 7 and will not be described further. What is stored in the vehicle ID field is the vehicle ID of each vehicle 10. The vehicle ID is assigned to each vehicle 10 in association with the IP address or the like by the server 30 when the vehicle 10 is registered in the advertisement display system 1. The advertisement information stored in the table in FIG. 8 may be replaced by information relating to advertisement data, such as video data, of an extracted part that is to be displayed by each vehicle 10 while it passes through a specific area.

FIG. 8 shows a vehicle group composed of three vehicles 10 respectively having the vehicles IDs of “V001”, “V002”, and “V003”, to which the group ID of “G001” is assigned. More specifically, the first vehicle 10A has the vehicle ID of “V001”, the second vehicle 10B has the vehicle ID of “V002”, and the third vehicle 10C has the vehicle ID of “V003”. The vehicles 10 composing the group having the group ID of “G0001” are to display an advertisement identified by the advertisement ID of “T002” successively in a specific area designated by the area ID of “D002”. The first vehicle 10A is to display an advertisement of a portion of the advertisement data associated with the advertisement ID of “T002” corresponding to the display information “C002_1” on its display apparatus 29. The second vehicle 10B is to display an advertisement of a portion of the advertisement data associated with the advertisement ID of “T002” corresponding to the display information “C002_2” on its display apparatus 29. The third vehicle 10C is to display an advertisement of a portion of the advertisement data associated with the advertisement ID of “T002” corresponding to the display information “C002_3” on its display apparatus 29. The number of vehicles 10 that belong to the group having the group ID of “G001” is the number of vehicles that are required to display the advertisement associated with the advertisement ID in its entirety. The number of vehicles 10 required is determined based on the respective speeds of the vehicles 10 and the length (or duration) of the advertisement.

Referring back to FIG. 5, the map information database 314 stores map information including map data and textual and pictorial POI (Point Of Interest) information illustrating features of places in the map. The map information database 314 may be provided by another system connected to the network N1, e.g. a geographic information system (GIS).

### Process Performed Vehicles

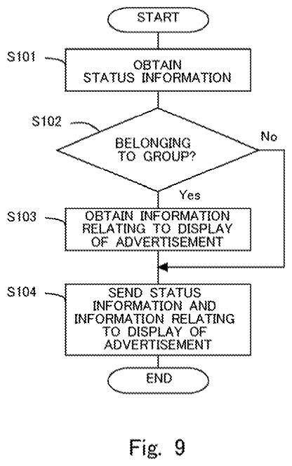

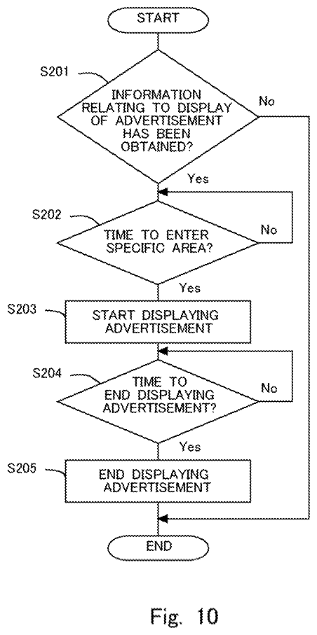

Next, a process performed by each vehicle 10 according to the first embodiment will be described with reference to FIGS. 9 and 10. FIG. 9 is a flow chart of an exemplary process of sending information relating to display of an advertisement from the vehicle 10 to the server 30. The process according to the flow chart of FIG. 9 is performed by the processor 21 on predetermined occasions (e.g. at regular intervals or in response to a request from the server 30).

In step S101 of this process, the processor 21 obtains status information indicating the status of the vehicle 10. Specifically, the processor 21 obtains location information by the location information sensor 27 and travel information by the travel information sensor 28. The processor 21 stores the location information and the travel information with associated time information that indicates the time at which they are obtained in a certain area of the main storage unit 22 temporarily, and the process proceeds to the processing of step S102. The processor 21 may obtain data of the degree of traffic congestion in the vicinity of the vehicle 10 and data relating to control of traffic signals obtained by road-to-vehicle communication and/or inter-vehicle communication and add such data to the status information.

In step S102, it is determined whether or not the vehicle 10 is belonging to a group of vehicles. If the vehicle 10 is belonging to a group, information relating to display of an advertisement sent from the server 30 is stored in the auxiliary storage unit 23 or other component. The processor 21 consults the auxiliary storage unit 23 or other component to determine whether or not the information relating to display of an advertisement is stored in it. If an affirmative determination is made in step S102, the process proceeds to step S103. If a negative determination is made in step S102, the process proceeds to step S104.

In step S103, the processor 21 retrieves information relating to display of an advertisement. Specifically, the processor 21 consults the auxiliary storage unit 23 or other component to retrieve information relating to display of an advertisement (e.g. group ID, advertisement ID, advertisement data, area ID, and display information) sent from the vehicle 10 from the server 30.

In step S104, the processor 21 sends the information obtained in step S101 or the information obtained in steps S101 and S103 to the server 30. More specifically, the processor 21 sends the information in association with the vehicle ID assigned to the vehicle 10 to the server 30. After the completion of the processing of step S104, the process according to the flow chart of FIG. 9 ends.

The vehicle 10 can send the status information relating to the state of travelling of itself to the server 30 by the above process. Moreover, when the vehicle 10 has already been put in a group of vehicles that are to display an advertisement, the vehicle 10 can send information relating to display of the advertisement to the server 30. The server 30 can select (or group) vehicles to be employed to display an advertisement using the status information and the information relating to display of an advertisement sent from the vehicles 10.

FIG. 10 is a flow chart of an exemplary process of displaying an advertisement on the display apparatus 29 of the vehicle 10. The process according to the flow chart of FIG. 10 is performed by the processor 21 on predetermined occasions (e.g. at regular intervals).

In step S201, the processor 21 determines whether or not information relating to display of an advertisement has already been received from the server 30. Information relating to display of an advertisement sent from the server 30 is stored in the auxiliary storage unit 23 or other component. Therefore, for example, the processor 21 consults the auxiliary storage unit 23 to determine whether the information relating to display of an advertisement is stored or not. If an affirmative determination is made in step S201, the process proceeds to step S202. If a negative determination is made, the process according to the flow chart of FIG. 10 is terminated.

In step S202, the processor 21 determines whether it is the time for the vehicle 10 to enter a specific area. The processor 21 determines the specific area based on the area ID. The correspondence between area IDs and specific areas is stored in advance in the auxiliary storage unit 23 or other component. If the present location of the vehicle 10 is near the specific area, the processer 21 determines that it is the time for the vehicle to enter the specific area. The present location of the vehicle 10 is acquired by the location information sensor 27. If an affirmative determination is made in step S202, the process proceeds to step S203. If a negative determination is made, the processing of step S202 is executed again.

In step S203, the processor 21 causes the display apparatus 29 to start display of an advertisement. The processor 21 causes the display apparatus 29 to display the advertisement associated with the advertisement ID. In this process, the processor 21 causes the display apparatus 29 to display a predetermined portion of the advertisement according to the display information. In step S204, the processor 21 determines whether it is the time to stop displaying the advertisement. The time to stop displaying the advertisement is determined based on the display information. It may be determined whether or not the vehicle 10 leaves the specific area based on the location information, and if it is determined that the vehicle 10 leaves specific area, the processor 21 may determine that it is the time to stop displaying the advertisement. If an affirmative determination is made in step S204, the process proceeds to step S205. If a negative determination is made, the processing of step S204 is executed again. Then, in step S205, the processor 21 causes the display apparatus 29 to stop displaying the advertisement.

By performing the above-described process, each of the vehicles 10 displays a portion of the advertisement allotted to it. As the grouped vehicles successively display successive portions of the advertisement, a consumer(s) located at the specific location can see the entirety of the advertisement.

### Process Performed by the Server

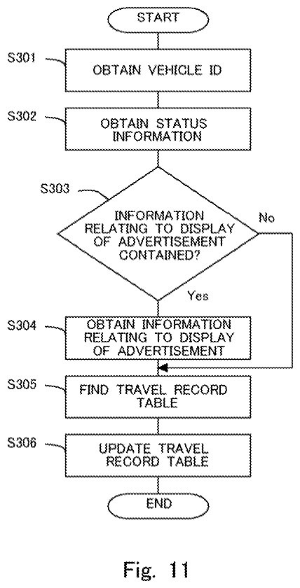

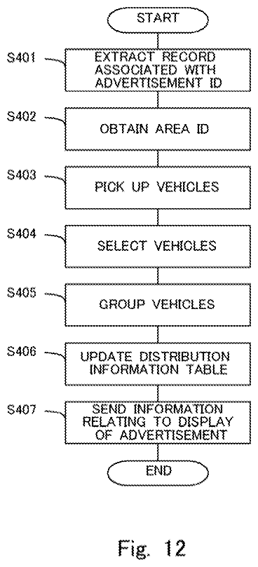

A process performed by the server 30 according to the first embodiment will now be described with reference to FIGS. 11 and 12. FIG. 11 is a flow chart of an exemplary process of managing vehicles. By performing the process according to the flow chart of FIG. 11, the server 30 obtains status information and information relating to display of an advertisement sent from the vehicles 10 on a vehicle-by-vehicle basis.

The process according to the flow chart of FIG. 11 is started, for example, when the server 30 receives status information and information relating to display of an advertisement sent from a vehicle 10. In step S301, the processor 31 obtains the vehicle ID sent from the vehicle 10. Moreover, in step S302, the processor 31 obtains the status information associated with the vehicle ID. If the status information includes data of the degree of traffic congestion in the vicinity of the vehicle 10, data about the speed of other vehicles present around the vehicle 10 and data relating to control of traffic signals obtained by road-to-vehicle communication and/or inter-vehicle communication, such data is also obtained as the status information. The processor 31 temporarily stores the status information thus obtained in a certain area of the main storage unit 32, and the process proceeds to step S303.

In step S303, it is determined whether or not information relating to display of an advertisement is included in the received information. If an affirmative determination is made in step S303, the process proceeds to step S304. If a negative determination is made, the process proceeds to step S305.

In step S304, the processor 31 obtains information relating to display of an advertisement. In step S305, the processor 31 searches the travel record database 312 using the vehicle ID obtained in step S301 as a search key to find the travel record table associated with this vehicle ID.

In step S306, the processor creates a record with time information in the travel record table found in step S305 and records the information obtained in step S301 or steps S501 and S304 in this record. Thus, the travel record table associated with the vehicle ID in the travel record database 312 is updated. After the completion of the processing of step S306, the process according to the flow chart of FIG. 11 ends.

By performing the above process, the processor 31 can search the travel record database 312 using the vehicle ID of the vehicle 10 to find the travel record table associated with that vehicle ID. Then, the processor 31 can record the status information (including location information, speed information, and information indicating the travel direction etc.) associated with the vehicle ID in the travel record table thus found. Likewise, the processor 31 can record the group ID, the display information and the advertisement ID in the travel record table associated with the vehicle ID. The processor 31 can select (or group) vehicles to be employed to display an advertisement based on information associated with respective vehicle IDs collected and stored in the travel record database 312.

Next, a process according to the flow chart of FIG. 12 will be described. FIG. 12 is a flow chart of an exemplary process of distributing an advertisement. By performing the process according to the flow chart of FIG. 12, the server 30 groups a plurality of vehicles 10 that meet a certain condition and sends portions of an advertisement to be displayed by the respective display apparatuses 29 of the vehicles 10. The process according to the flow chart of FIG. 12 is performed by the processor at regular intervals for each advertisement ID by consulting the advertisement information database 311 and the travel record database 312.

In step S401 of the process according to the flow chart of FIG. 12, the processor 31 consults the advertisement database 311 to extract the record associated with the advertisement ID for which this process is executed. The extracted record is temporarily stored in a certain area of the main storage unit 32.

In step S402, the processor 31 obtains information indicating the area ID stored in the extracted record.

In step S403, the processor 31 picks up a plurality of vehicles 10 that are expected to travel in the specific area designated by the area ID based on the present locations and directions of travel of the vehicles 10. Specifically, the processor 31 consults the travel record database 312 to pick up all the vehicles 10 whose present location is outside the specific area designated by the area ID and whose travel direction is toward the specific area, from among the vehicles 10 whose group ID field is blank or reads “---”. Information about all the vehicles 10 picked up in this way is passed to the processing of step S404. These vehicles 10 will also be referred to as “picked-up vehicles” hereinafter.

In step S404, the processor 31 selects vehicles that meet a condition for displaying the advertisement from among the picked-up vehicles. The vehicles thus selected will also be referred to as “display vehicles” hereinafter. For example, the processor 31 selects vehicles that are expected to be located in the specific area in a specific period from among the picked-up vehicles. Whether or not each vehicle 10 is expected to be located in the specific area in the specific period is determined based on the present location, the present speed, and the present direction of travel of the vehicle 10. The processor 31 may select vehicles 10 that will not travel in the specific area at the same time to form a group of vehicles 10. The processor 31 selects the display vehicles in the order of their entrance into the specific area. The processor 31 selects as many display vehicles as required to display the entirety of the advertisement. The processor 31 selects display vehicles from among the picked-up vehicles in the order of their entrance into the specific area and adds up the times over which the respective vehicles 10 display the advertisement in the specific area, namely the times over which the respective vehicles 10 are located in the specific area. The processor 31 continues to select display vehicles until the added-up time reaches the time equal to the entire length of the advertisement.

When selecting the vehicles 10, the processor 31 may consult the map information database 314. The processor 31 can recognize the roads that vehicles 10 are travelling and the locations of traffic signals provided in the roads by using map data of the area corresponding to the area ID. The processor 31 may access a vehicle information and communication system (VICS: registered trademark) or the like via the network N1 to obtain information about traffic jam or other information. Moreover, the processor 31 may obtain information about the degree of traffic congestion in the vicinity of each vehicle 10, information about the speed of other vehicles around each vehicle 10, and information about control of traffic signals obtained by each vehicle 10 by road-to-vehicle communication and/or inter-vehicle communication. Since such information relates to the vehicle speed, the processor 31 may calculate the vehicle speed based on such information to select vehicles 10. The aforementioned information about traffic jam, information about the degree of traffic congestion in the vicinity of each vehicle, and information about control of traffic signals are examples of the traffic information according to the present disclosure.

The processor 31 temporarily stores information about the selected vehicles 10 in a certain area of the main storage unit 32 and executes the processing of step S405 next.

In step S405, the processor 31 assigns a group ID to the selected vehicles 10 to group these vehicles 10. The group ID assigned to the vehicles 10 is passed to the processing of step S406.

In step S406, the processor 31 records the vehicle IDs of the vehicles 10 assigned with the group ID and information relating to the advertisement distributed to these vehicles 10 in association with each other in the distribution information database 313. The processor 31 creates a record for each of the group IDs assigned to vehicles 10, and stores the advertisement ID of the advertisement to be displayed and information indicating the area ID in this record. The processor 31 also stores in a record for each group ID the vehicle IDs and display information of the vehicles 10 that constitute the group. The display information associated with each vehicle ID is created based on the order of entrance of the vehicle 10 into the specific area and the time over which the vehicle 10 displays the advertisement in the specific area. For example, display information corresponding to the first period in FIG. 3 is stored in association with the vehicle ID (V001) of the first vehicle 10A. Likewise, display information corresponding to the second period in FIG. 3 is stored in association with the vehicle ID (V002) of the second vehicle 10B, and display information corresponding to the third period in FIG. 3 is stored in association with the vehicle ID (V003) of the third vehicle 10C.

Then, in step S407, the processor 31 sends information relating to display of the advertisement to the vehicles 10 assigned with the group ID. After the completion of the processing of step S407, the process according to the flow chart of FIG. 12 ends.

The grouped vehicles 10 receive the information relating to display of the advertisement sent from the server 30. Each of the vehicle 10 stores the information relating to display of the advertisement it has received in a certain area of the main storage unit 22 temporarily. Then, the processor 21 of each vehicle 10 causes the display apparatus 29 to display the advertisement based on the information relating to display of the advertisement. The grouped vehicles altogether display the respective portions of the advertisement allotted to them on their display apparatuses 29 to display the advertisement continuously.

As above, the advertisement display system 1 according to the first embodiment causes a succeeding vehicle to display the portion of the advertisement continued from the portion displayed by a preceding vehicle to allow a consumer to see the entirety of the advertisement. Therefore, the advertisement display system according to the first embodiment can enhance the effectiveness of the advertisement.

### Modification

The advertisement display system 1 according to the first embodiment selects display vehicles before starting display of an advertisement. Alternatively, the advertisement display system 1 may select a vehicle 10 that can display a portion of the advertisement continued from the portion displayed by a preceding vehicle every time when the preceding vehicle leaves the specific area. The speed of a vehicle 10 may become low or zero for example when the vehicle 10 stops at a signal or a traffic jam is occurring around the vehicle 10. On such occasions, the vehicle 10 can display the advertisement in the specific area for a longer time. It is possible to divide the advertisement into portions in advance by collecting information about signals and/or traffic jams. However, it is difficult to predict the speed of the vehicle 10 precisely in some cases. If a vehicle 10 that can display a portion of the advertisement continued from the portion that has been actually displayed by a preceding vehicle is selected on the fly, it is possible to cause a succeeding vehicle to display a portion of the advertisement that is determined according to the length of time over which the preceding vehicle has actually travelled in the specific area. Therefore, it is possible to display the advertisement with enhanced efficiency.

When a vehicle 10 leaves the specific area while displaying an advertisement, the processor 21 of the vehicle 10 sends information about the point in the advertisement that is displayed at the time when the vehicle 10 leaves the specific area (e.g. information about the elapsed time from the beginning of the advertisement) to the server 30. After receiving this information, the processor 31 of the server 30 selects a vehicle 10 that will enter the specific area next or a vehicle 10 that has already been travelling in the specific area. Moreover, the server 30 sends display information to the selected vehicle 10 so that the vehicle 10 will display, in the specific area, a portion of the advertisement starting from the point in the advertisement displayed by the preceding vehicle at the time of its leaving of the specific area.

### Second Embodiment

While the advertisement display system 1 according to the first embodiment does not vary the length of advertisements, the advertisement display system 1 according to the second embodiment varies the length of advertisements according to circumstances. There may be cases where the length of an advertisement is so long that it is difficult to display the entirety of the advertisement only by vehicles 10 that pass through a specific area. For example, there may be cases where the number of vehicles 10 that pass through the specific area is not large enough to display the advertisement till the end. There may also be cases where the length of time over which vehicles 10 can display an advertisement is short because the speed of vehicles 10 travelling in the specific area is high, making it difficult for them to display the advertisement till the end. To avoid such situations from occurring, the advertisement display system 1 according to the second embodiment selects the entire length of the advertisement so as to allow a consumer located at a specific location to see the entirety of the advertisement.

For example, the advertisement to be displayed is selected in such a way that the fewer the vehicles 10 capable of displaying the advertisement is, the shorter the length of the advertisement is. Specifically, a plurality of advertisements having different entire lengths (durations) are prepared in advance, and the length of the advertisement to be displayed is switched based on the length of time over which the display apparatuses 29 of the vehicles 10 can be seen from a specific location. For example, when the vehicles 10 are at a standstill waiting at a red light for a long or when the speed of the vehicles 10 is low due to a traffic jam, it is possible to allow the consumer to see the advertisement for a longer time. Therefore, when the vehicles 10 stop at a red light or when a traffic jam is occurring, the advertisement is switched to display an advertisement having a long length.

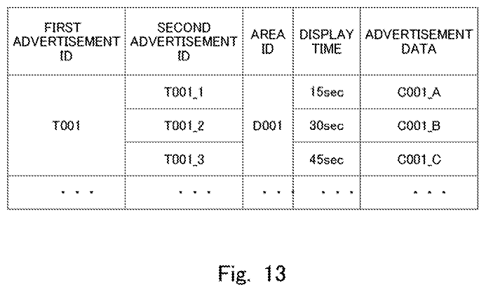

FIG. 13 illustrates an example of advertisement information stored in an advertisement information database 311 according to the second embodiment. The advertisement information is managed as an advertisement information table as illustrated in FIG. 13. The fields of information stored in the advertisement information table may be added, changed, and deleted fitly.

The exemplary advertisement information table in FIG. 13 includes the fields of first advertisement ID, second advertisement ID, area ID, display time, and advertisement data. What is stored in the first advertisement ID field is identification information that identifies a group of advertisements received from an advertiser. The first advertisement ID is assigned to the advertisements when they are registered. What is stored in the second advertisement ID field is second advertisement IDs as identification data identifying the plurality of advertisements associated with the first advertisement ID. The second advertisement IDs are information identifying advertisements associated with the first advertisement ID that have different durations. What is stored in the area ID field is information (area ID) indicating an area in which vehicles 10 are caused to display the advertisement while travelling. The area ID is information designating the aforementioned specific area. What is stored in the display time field is information indicating the time required to display the entirety of the advertisement associated with each second advertisement ID, namely the duration of the advertisement associated with each second advertisement ID. What is stored in the advertisement data field is information relating to data of advertisement associated with each second advertisement ID. The information stored in the advertisement data field may be an identification number that designates advertisement data stored in another table or the like.

The processor 31 of the server 30 selects the second advertisement ID associated with an advertisement to be displayed by vehicles 10 based on the status information of the vehicles 10 located in a specific area in a specific period and the respective display times of the advertisements associated with the second advertisement IDs shown in FIG. 13. For example, the processor calculates the length of time over which vehicles 10 located in a specific area in a specific period can display an advertisement and selects the longest advertisement from among the advertisements shorter than the calculated time. Then, the server 30 sends information relating to display of the advertisement (including the group ID, the second advertisement ID, advertisement data, the area ID, and display information etc.) to the vehicles 10.

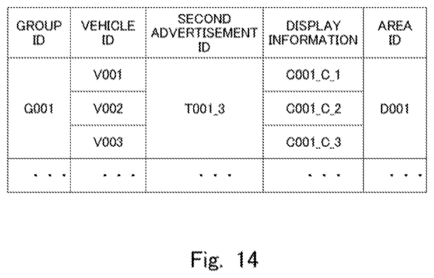

FIG. 14 illustrates exemplary distribution information stored in the distribution information database 313 according to the second embodiment. The distribution information is managed as a distribution information table as illustrated in FIG. 14. The fields of information stored in the distribution information table may be added, changed, and deleted fitly.

The exemplary distribution information table in FIG. 14 includes the fields of group ID, vehicle ID, second advertisement ID, display information, and area ID. The group ID, the vehicle ID, and the area ID are the same as those in FIG. 8 and will not be described further. The second advertisement ID is the same as that in FIG. 13 and will not be described further.

What is stored in the display information field is information indicating the portion of advertisement associated with the second advertisement ID that is to be displayed. The display information stored in this field may be replaced by information relating to data (such as video data) of an extracted portion of the advertisement to be displayed by each vehicle 10 when travelling in the specific area.

FIG. 14 shows a vehicle group composed of three vehicles 10 having the vehicles IDs of “V001”, “V002”, and “V003”, to which the group ID of “G001” is assigned. In the illustrative case in FIG. 14, the advertisement identified by the second advertisement ID of “T001_3” is selected as the advertisement to be displayed by the vehicles 10 in the vehicle group assigned with the group ID of “G001”. The vehicle ID of the first vehicle 10A is V001, the vehicle ID of the second vehicle 10B is V002, and the vehicle ID of the third vehicle 10C is V003. The vehicles 10 composing the group assigned with the group ID of “G001” display portions of the advertisement identified by the second advertisement ID of “T001_3” successively in the specific area designated by the area ID of “D001”. The first vehicle 10A displays the portion of the advertisement identified by the second advertisement ID of “T001_3” that is specified by the display information “C001_C_1” on its display apparatus 29. The second vehicle 10B displays the portion of the advertisement identified by the second advertisement ID of “T001_3” that is specified by the display information “C001_C_2” on its display apparatus 29. The third vehicle 10C displays the portion of the advertisement identified by the second advertisement ID of “T001_3” that is specified by the display information “C001_C_3” on its display apparatus 29.

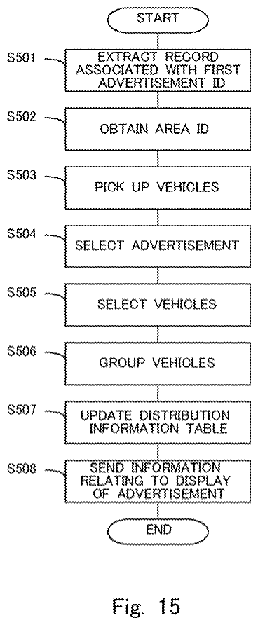

FIG. 15 is a flow chart of an exemplary process of distributing an advertisement according to the second embodiment. By performing the process according to the flow chart of FIG. 15, the server groups a plurality of vehicles 10 that meet a certain condition and causes the vehicles 10 to display respective portions of an advertisement by their display apparatuses 29. The process according to the flow chart of FIG. 15 is performed by the processor 31 at regular intervals for each advertisement ID by consulting the advertisement information database 311 and the travel record database 312. As illustrated in FIG. 9, status information and information relating to display of an advertisement are sent from each vehicle 10 to the server 30 at regular intervals.

In step S501 of the process according to the flow chart of FIG. 15, the processor 31 consults the advertisement database 311 to extract the record associated with the advertisement ID for which this process is executed. The extracted record is temporarily stored in a certain area of the main storage unit 32.

In step S502, the processor 31 obtains information indicating the area ID stored in the extracted record. The processor 31 passes the information indicating the area ID to the processing of step S503.

In step S503, the processor 31 picks up a plurality of vehicles 10 that are expected to travel in the specific area designated by the area ID in a certain period based on the present locations and directions of travel of vehicles 10. Specifically, the processor 31 consults the travel record database 312 to determine whether or not the vehicles 10 whose group ID field is blank or reads “---” will travel in the specific area in the certain period based on the present location, the present speed, and the present direction of travel and pick up vehicles 10 that are expected to travel in the specific area in the certain period. The processor 31 may select vehicles 10 in such a way that vehicles 10 will not travel in the specific area at the same time are grouped.

When picking up the vehicles 10, the processor 31 may consult the map information database 314. The processor 31 can recognize the roads that vehicles 10 are travelling and the locations of traffic signals provided in the roads by using map data of the area corresponding to the area ID. Moreover, the processor 31 may access a vehicle information and communication system (VICS: registered trademark) or the like via the network N1 to obtain information about traffic jam or other information. When picking up vehicles 10, furthermore, the processor 31 may obtain information about the degree of traffic congestion in the vicinity of each vehicle 10, information about the speed of other vehicles around each vehicle 10, and information about control of traffic signals obtained by each vehicle 10 by road-to-vehicle communication and/or inter-vehicle communication. Information about all the vehicles 10 picked up in this way is passed to the processing of step S504. These vehicles 10 will also be referred to as “picked-up vehicles” hereinafter.

In step S504, the processor 31 selects an advertisement to be displayed by the picked-up vehicles 10 based on the time over which the picked-up vehicles will display the advertisement in the specific area. Specifically, the processor adds up the times over which the respective picked-up vehicles will display the advertisement in the specific area, namely the times over which the respective vehicles 10 are located in the specific area. Then, the processor 31 compares the added-up time for all the picked-up vehicles and the display times associated with the respective second advertisement IDs and selects the second advertisement ID of which the display time is longest among the second advertisement IDs of which the display time is shorter than the added-up time as the ID of the advertisement to be displayed by the vehicles 10.

In step S505, the processor 31 selects vehicles that meet a condition for displaying the advertisement from among the picked-up vehicles. The vehicles thus selected will also be referred to as “display vehicles” hereinafter. The processor 31 selects display vehicles from among the picked-up vehicles in the order of their entrance into the specific area and adds up the times over which the respective vehicles 10 will display the advertisement in the specific area, namely the times over which the respective vehicles 10 will be located in the specific area. The processor 31 continues to select display vehicles until the added-up time reaches the time equal to the entire length (or display time) of the advertisement associated with the second advertisement ID. The processor 31 temporarily stores information about the selected vehicles in a certain area of the main storage unit 32 and executes the processing of step S506 next. Then, in step S506, the processor 31 assigns a group ID to the selected vehicles 10 to group these vehicles 10.

In step S507, the processor 31 records the vehicle IDs of the vehicles 10 assigned with the group ID and information relating to the advertisement distributed to these vehicles 10 in association with each other in the distribution information database 313. The processor 31 creates a record for each of the group IDs assigned to vehicles 10, and stores the second advertisement ID of the advertisement to be displayed and information indicating the area ID in this record. The processor 31 also stores in a record for each group ID the vehicle IDs and display information of the vehicles 10 that constitute the group. The display information associated with each vehicle ID is created based on the order of entrance of the vehicle 10 into the specific area and the time over which the vehicle 10 displays the advertisement in the specific area.

Then, in step S508, the processor 31 sends information relating to display of the advertisement to the vehicles 10 assigned with the group ID. After the completion of the processing of step S508, the process according to the flow chart of FIG. 15 ends.

The grouped vehicles 10 receive the information relating to display of the advertisement sent from the server 30. Each of the vehicle 10 stores the information relating to display of the advertisement it has received in a certain area of the main storage unit 22 temporarily. Then, the processor 21 of each vehicle 10 causes the display apparatus 29 to display the advertisement based on the information relating to display of the advertisement. The grouped vehicles altogether display the respective portions of the advertisement allotted to them on their display apparatuses 29 to display the advertisement continuously.

As above, the advertisement display system 1 according to the second embodiment selects an advertisement having a length that can be displayed in a certain period, thereby allowing a consumer(s) to see the entirety of the advertisement. Therefore, the advertisement display system according to the second embodiment can enhance the effectiveness of the advertisement.

### Third Embodiment

An advertisement display system 1 according to the third embodiment changes the content of the advertisement to be displayed by vehicle 10 according to circumstances. For example, in the case where an advertisement displayed by vehicles 10 contains letters (or characters) and figures, the amount and size of letters and the shape of figures that a consumer can recognize change depending on the speed of the vehicles 10. In other words, the lower the speed of the vehicles 10 is, the larger the amount of information contained in the advertisement that the consumer can recognize is. The advertisement display system 1 according to the third embodiment is configured to cause vehicles 10 to display an advertisement containing a smaller amount of information when the speed of the vehicle 10 is high than when it is low. The advertisement display system 1 may cause the vehicles 10 to display an advertisement containing a relatively small amount of information when the speed of the vehicles 10 is higher than a certain speed and an advertisement containing a relatively large amount of information when the speed of the vehicles is lower than that speed. The speed of the vehicles 10 mentioned above may be the average speed of the vehicles 10, the highest speed among the vehicles 10, or the lowest speed among the vehicles 10.

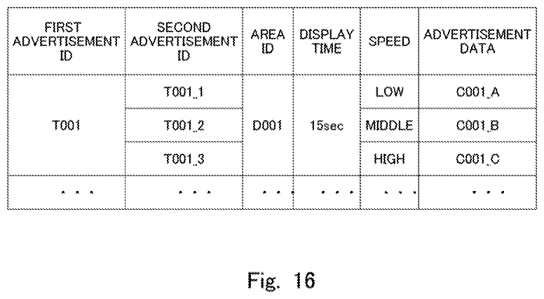

FIG. 16 illustrates exemplary advertisement information stored in the advertisement information database 311 according to the third embodiment. The advertisement information is managed as an advertisement information table as illustrated in FIG. 16. The fields of information stored in the advertisement information table may be added, changed, and deleted fitly.

The exemplary advertisement information table in FIG. 16 includes the fields of first advertisement ID, second advertisement ID, area ID, display time, speed, and advertisement data. What is stored in the first advertisement ID field is the first advertisement ID as identification information that identifies a group of advertisements received from an advertiser. The first advertisement ID is assigned to the advertisements when they are registered. What is stored in the second advertisement ID field is second advertisement IDs as identification data identifying the plurality of advertisements associated with the first advertisement ID. The second advertisement IDs are information identifying advertisements associated with the first advertisement ID that contain different amounts of information. What is stored in the area ID field is information (area ID) indicating an area in which vehicles 10 are caused to display the advertisement while travelling. The area ID is information designating the aforementioned specific area. What is stored in the display time field is information indicating the time required to display the entirety of the advertisement associated with each second advertisement ID, namely the duration of the advertisement associated with each second advertisement ID.

What is stored in the speed field is information about the speed of vehicles 10 associated with the second advertisement ID. In the case illustrated in FIG. 16, the speeds of vehicles 10 are divided into three ranges, namely low, middle, and high. “LOW” in FIG. 16 indicates a speed range in which the speed of vehicles 10 is relatively low. “MIDDLE” in FIG. 16 indicates a speed range in which the speed of vehicles 10 is higher than the low speed range. “HIGH” in FIG. 16 indicates a speed range in which the speed of vehicles 10 is higher than the middle speed range. What is stored in the advertisement data field is information relating to data of advertisement associated with each second advertisement ID. The information stored in the advertisement data field may be an identification number that designates advertisement data stored in another table or the like. Advertisement data associated with a second advertisement ID for which the speed is “LOW” is data having the largest amount of information. Advertisement data associated with a second advertisement ID for which the speed is “MIDDLE” is data having a medium amount of information. Advertisement data associated with a second advertisement ID for which the speed is “HIGH” is data having the smallest amount of information. The amount of information refers to the amount of information of the content displayed on the display apparatus 29. The amount of information as such is determined based on the amount of information that the consumer can recognize. For example, the larger the size of letters (or characters) is, the smaller the number of letters that can be displayed on the display apparatus 29 is and therefore, the smaller the amount of information of the content displayed on the display apparatus 29 is. The smaller the number of letters is, the smaller the amount of information of the content displayed on the display apparatus 29 is. The larger the size of figures is, the smaller the number of figures that can be displayed on the display apparatus 29 is and therefore, the smaller the amount of information of the content displayed on the display apparatus 29 is.

The processor 31 of the server 30 selects the second advertisement ID associated with the advertisement to be displayed by vehicles 10 on the basis of the status information of vehicles 10 located in a specific area and the speed associated with the second advertisement ID in FIG. 16. Then, the processor 31 sends information relating to display of the advertisement (including the group ID, the second advertisement ID, advertisement data, the area ID, and display information etc.) to the vehicles 10. The advertisement display system 1 according to the third embodiment creates a database similar to the distribution information database 313 illustrated in FIG. 14.

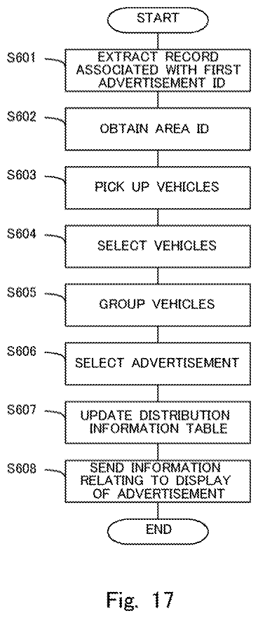

FIG. 17 is a flow chart of an exemplary process of distributing an advertisement according to the third embodiment. By performing the process according to the flow chart of FIG. 17, the server 30 groups a plurality of vehicles 10 that meet a certain condition and sends portions of an advertisement to be displayed by the respective display apparatuses 29 of the vehicles 10. The process according to the flow chart of FIG. 17 is performed by the processor 31 at regular intervals for each advertisement ID by consulting the advertisement information database 311 and the travel record database 312. As illustrated in FIG. 9, status information and information relating to display of an advertisement are sent from each vehicle 10 to the server 30 at regular intervals.

In step S601 of the process according to the flow chart of FIG. 17, the processor 31 consults the advertisement database 311 to extract the record associated with the advertisement ID for which this process is executed. The extracted record is temporarily stored in a certain area of the main storage unit 32.

In step S602, the processor 31 obtains information indicating the area ID stored in the extracted record. The processor 31 passes the information indicating the area ID to the processing of step S603.

In step S603, the processor 31 picks up a plurality of vehicles 10 that are expected to travel in the specific area designated by the area ID based on the present locations and directions of travel of vehicles 10. Specifically, the processor 31 consults the travel record database 312 to pick up all the vehicles 10 whose present location is outside the specific area designated by the area ID and whose travel direction is toward the specific area, from among the vehicles 10 whose group ID field is blank or reads “---”. Information about all the vehicles 10 picked up in this way is passed to the processing of step S604. These vehicles 10 will also be referred to as “picked-up vehicles” hereinafter.

In step S604, the processor 31 selects vehicles that meet a condition for displaying the advertisement from among the picked-up vehicles. The vehicles thus selected will also be referred to as “display vehicles” hereinafter. For example, the processor 31 selects vehicles that are expected to be located in the specific area in a specific period from among the picked-up vehicles. Whether or not each vehicle 10 is expected to be located in the specific area in the specific period is determined based on the present location, the present vehicle speed, and the present direction of travel of the vehicle 10. The processor 31 may select vehicles 10 that will not travel in the specific area at the same time to form a group of vehicles 10. The processor 31 selects the display vehicles in the order of their entrance into the specific area. The processor 31 selects as many display vehicles as required to display the entirety of the advertisement. The processor 31 selects display vehicles from among the picked-up vehicles in the order of their entrance into the specific area and adds up the times over which the respective vehicles 10 display the advertisement in the specific area, namely the times over which the respective vehicles 10 are located in the specific area. The processor 31 continues to select display vehicles until the added-up time reaches the time equal to the entire length of the advertisement.

When selecting the vehicles 10, the processor 31 may consult the map information database 314. The processor 31 can recognize the roads that vehicles 10 are travelling and the locations of traffic signals provided in the roads by using map data of the area corresponding to the area ID. The processor 31 may access a vehicle information and communication system (VICS: registered trademark) or the like via the network N1 to obtain information about traffic jam or other information. When selecting the vehicles 10, moreover, the processor 31 may take into account information about the degree of traffic congestion in the vicinity of each vehicle 10, information about the speed of other vehicles around each vehicle 10, and information about control of traffic signals obtained by each vehicle by road-to-vehicle communication and/or inter-vehicle communication.

The processor 31 temporarily stores information about the selected vehicles 10 in a certain area of the main storage unit 32 and executes the processing of step S605 next.

In step S605, the processor 31 assigns a group ID to the selected vehicles 10 to group these vehicles 10.

In step S606, the processor 31 selects an advertisement to be displayed by the vehicles 10 based on information about the speed of display vehicles. For example, the processor 31 selects the second advertisement ID associated with an advertisement to be displayed by the vehicles 10 based on the average speed of all the display vehicles that pass through the specific area and the speed associated with the second advertisement ID in FIG. 16.

In step S607, the processor 31 records the vehicle IDs of the vehicles 10 assigned with the group ID and information relating to the advertisement distributed to these vehicles 10 in association with each other in the distribution information database 313. The processor 31 creates a record for each of the group IDs assigned to vehicles 10, and stores the second advertisement ID of the advertisement to be displayed and information indicating the area ID in this record. The processor 31 also stores in a record for each group ID the vehicle IDs and display information of the vehicles 10 that constitute the group. The display information associated with each vehicle ID is created based on the order of entrance of the vehicle 10 into the specific area and the time over which the vehicle 10 displays the advertisement in the specific area.

Then, in step S608, the processor 31 sends information relating to display of the advertisement to the vehicles 10 assigned with the group ID. After the completion of the processing of step S608, the process according to the flow chart of FIG. 17 ends.

The grouped vehicles 10 receive the information relating to display of the advertisement sent from the server 30. Each of the vehicle 10 stores the information relating to display of the advertisement it has received in a certain area of the main storage unit 22 temporarily. Then, the processor 21 of each vehicle 10 causes the display apparatus 29 to display the advertisement based on the information relating to display of the advertisement. The grouped vehicles altogether display the respective portions of the advertisement allotted to them on their display apparatuses 29 to display the advertisement continuously.

As above, the advertisement display system 1 according to the third embodiment selects the advertisement to be displayed by vehicles 10 according to the speed of the vehicles 10 to allow consumers to recognize the advertisement more clearly and grasp a larger amount of information. Therefore, the advertisement display system 1 according to the third embodiment can enhance the effectiveness of the advertisement.

### Other Embodiments

The above embodiments are only for the illustrative purpose. Appropriate modifications can be made thereto without departing from the essence of the present disclosure. While in the embodiments described above the server 30 has the vehicle management part 301, the vehicle selection part 302, the advertisement distribution part 303, the advertisement information database 311, the travel record database 312, the distribution information database 313, and the map information database 314 as functional components, some or all of these functional components may be included in the vehicle 10.

The processing and means that have been described in the foregoing may be employed in any combination so long as it is technically feasible to do so.

A process described to be performed by one apparatus may be performed by a plurality of apparatuses in a distributed manner. A process described to be performed by different apparatuses may be performed by a single apparatus. The hardware configuration (server configuration) employed to implement various functions in a computer system may be modified flexibly.

The present disclosure can be carried out by supplying a computer program(s) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus that causes a plurality of vehicles each provided with a display apparatus capable of displaying an advertisement to the outside to display an advertisement, comprising a controller configured to execute the processing of:
obtaining speed information defined as information relating to the speed of the plurality of vehicles passing through a specific area in the specific area, the specific area being such an area that the display apparatuses of the vehicles travelling in this area can be seen from a specific location; and
if a first vehicle among the plurality of vehicles that is displaying the advertisement in the specific area leaves the specific area before completing the display of the advertisement, causing a second vehicle among the plurality of vehicles that enters the specific area later than the first vehicle to display the advertisement upon entering the specific area in such a way as to start the display of the advertisement from the point in the advertisement displayed by the display apparatus of the first vehicle at the time of its leaving of the specific area, said point in the advertisement being determined based on the speed information.

2. An information processing apparatus according to claim 1, wherein the controller is configured to further execute the processing of dividing the advertisement based on the speed information relating to vehicles among the plurality of vehicles that enter the specific area in order and causing the display apparatuses of the vehicles to respectively display the divided portions of the advertisement according to the order of their entrance into the specific area.

3. An information processing apparatus according to claim 1, wherein the controller varies the length of the advertisement based on the speed information relating to vehicles among the plurality of vehicles that enter the specific area in a specific period.

4. An information processing apparatus according to claim 1, wherein the controller is configured to further execute the processing of:
obtaining traffic information defined as information relating to traffic in the specific area; and
obtaining the speed information based on the traffic information.

5. An information processing apparatus according to claim 1, wherein the higher the speed of the plurality of vehicles in the specific area is, the more the controller decreases the amount of information contained in the advertisement.

6. An information processing method for causing a plurality of vehicles each provided with a display apparatus capable of displaying an advertisement to the outside to display an advertisement, comprising:
obtaining speed information defined as information relating to the speed of the plurality of vehicles passing through a specific area in the specific area, the specific area being such an area that the display apparatuses of the vehicles travelling in this area can be seen from a specific location; and
if a first vehicle among the plurality of vehicles that is displaying the advertisement in the specific area leaves the specific area before completing the display of the advertisement, causing a second vehicle among the plurality of vehicles that enters the specific area later than the first vehicle to display the advertisement upon entering the specific area in such a way as to start the display of the advertisement from the point in the advertisement displayed by the display apparatus of the first vehicle at the time of its leaving of the specific area, said point in the advertisement being determined based on the speed information.

7. A non-transitory storage medium storing a program configured to cause a computer to execute the process of causing a plurality of vehicles each provided with a display apparatus capable of displaying an advertisement to the outside to display an advertisement, the process comprising:
obtaining speed information defined as information relating to the speed of the plurality of vehicles passing through a specific area in the specific area, the specific area being such an area that the display apparatuses of the vehicles travelling in this area can be seen from a specific location; and
if a first vehicle among the plurality of vehicles that is displaying the advertisement in the specific area leaves the specific area before completing the display of the advertisement, causing a second vehicle among the plurality of vehicles that enters the specific area later than the first vehicle to display the advertisement upon entering the specific area in such a way as to start the display of the advertisement from the point in the advertisement displayed by the display apparatus of the first vehicle at the time of its leaving of the specific area, said point in the advertisement being determined based on the speed information.
